(19) United States
(12) Patent Application Publication
(10) Pub. No.: US 2014/0249779 A1
(43) Pub. Date: Sep. 4, 2014

(54) METHOD AND APPARATUS FOR DETERMINING AND PRESENTING DIFFERENCES BETWEEN 3D MODELS

(71) Applicant: Gehry Technologies, Inc., (US)

(72) Inventors: Jim Chi-Kwan CHEUNG, Santa Monica, CA (US); Dennis SHELDEN, Calabasas, CA (US)

(73) Assignee: GEHRY TECHNOLOGIES, INC., Los Angeles, CA (US)

(21) Appl. No.: 13/740,262

(22) Filed: Jan. 14, 2013

Related U.S. Application Data
(63) Continuation-in-part of application No. 13/717,371, filed on Dec. 17, 2012.
Application No. 13/717,371 is a continuation-in-part of application No. 13/717,620, filed on Dec. 17, 2012.
(60) Provisional application No. 61/586,043, filed on Jan. 12, 2012.
(60) Provisional application No. 61/576,921, filed on Dec. 16, 2011.
(60) Provisional application No. 61/576,892, filed on Dec. 16, 2011.

(51) Int. Cl. G06F 17/50

(52) U.S. Cl. CPC G06F 17/50
USPC 703/1

(57) ABSTRACT

The disclosed embodiments enable automatic and digital comparison of complex 2D and 3D models to identify changes between the models, including additions, deletions and moves. The disclosed embodiments also enable a method for displaying composite image(s) with changes highlighted in one or more color or shade for easy detection and analysis of the changes.

The instant application claims priority to Provisional Application Ser. No. 61/586,043 (filed Jan. 12, 2012); Provisional Application Ser. No. 61/576,921 (filed Dec. 16, 2011), Provisional Application Ser. No. 61/576,892 (filed Dec. 16, 2011), application Ser. No. 13/717,371 (filed Dec. 17, 2012), and application Ser. No. 13/717,620, filed Dec. 17, 2012; the disclosure of these applications are incorporated herein in their entirety.

### BACKGROUND

1. Field of the Invention

The disclosure relates to method and apparatus for identifying changes among different versions of a drawing. More specifically, the disclosure relates to novel method and apparatus for identifying version changes in large two-dimensional (“2D”) and/or three-dimensional (3D) drawings.

2. Description of Related Art

The use of 3D models built by computer aided modeling design (CAD) tools has improved the ability to design and build three dimensional structures. CAD models enable structural, mechanical, electrical and plumbing designs with great efficiency. The electronic design files may also be used to control machine operations. Such designs may be for buildings, ships, automobiles and the like. The design typically includes the overall structure as well as the individual parts of the structure. CAD tools have alleviated the need for hand-drawn plans and have vastly improved design efficiency and accuracy.

One important aspect of the design is the ability to track changes to a design, and to see differences between one iteration of a design and another iteration. This requires that two (or more) 3D models be compared, changes identified, changes accepted or rejected and then presented for viewing. The conventional method for accomplishing this task has been visual inspection.

The 3D models to be compared are printed on transparent media and overlaid. The viewer then attempts to match up the designs where they are similar, so that the differences will show up as crossed lines. In some cases, the images are printed in different color ink so that the presence of a new line or the absence of an old portion of the structure can be more easily identified. In some instances, such comparison is a two-stage process with the layer on top changing for each stage, allowing hidden lines to be identified.

Conventional CAD models typically include different files with each file defining an aspect of the design. For example, a building's CAD model may include a structural CAD file, an electrical CAD file, a plumbing CAD file and a mechanical CAD file. Different designers may collaborate or be independently responsible for each aspect of the design. Moreover, on a distributed platform, different teams may be working and improving different aspects of the design and thereby creating new versions of the CAD model. It is important to detect changes between the different versions created by different teams. The design files are complex data files consuming much of the processor's bandwidth. Printing each version of the file and visually inspecting to identify the change(s) is not efficient nor possible in many instances. Moreover, when conventional design files have different formats, a project coordinator may have to facilitate information transfer between incompatible design files before comparing files.

The visual version control and change identification relies on the human viewer to identify minute changes in a complex engineering drawing. The human viewer may miss changes due to the complexity of the model. Another disadvantage is that depending on the view of the 3D model printed, some features that may have been changed will be eclipsed by other objects and not readily apparent. In addition to being error prone, the conventional process is also time consuming.

### SUMMARY

The disclosed embodiments enable automatic and digital comparison of 3D models to identify changes between the models, including additions, deletions and moves. The disclosed embodiments also enable a method for displaying composite image(s) with changes highlighted in one or more color or shade for easy detection and analysis.

In one embodiment, the system considers meta data files that may be associated with a 3D model. Such meta-data may include names and unique ID information, location, technical specification, and other relevant information, for individual components that comprise a model. For example, if the model represents a building, the meta-data (objects) could comprise windows, doors, furniture, walls, ceilings, floors and other components. By comparing the meta-data of two 3D models, differences can be identified. For example, the presence, absence or movement of one or more windows can be readily identified by such comparison. In another embodiment, the system compares a listing of all elements of a 3D model, such as, vectors, splines and surfaces to find common elements and branching out from there to identify differences. The highlighted difference in the meta-data must reflect the most relevant object. In an example, dimensional differences on a number of mullions, sashes, apron, etc. that are part of only one particular window should be reported as a difference in one window and not all its parts.

In another embodiment, the disclosure relates to a method for identifying changes among different versions of a three-dimensional (“3D”) modeling file. The method comprises the steps of: (a) receiving at a processor a first file version and a second file version of the 3D mode file, each of the first file version and the second file version containing a plurality of objects; (b) forming a plurality of data files, each data file receiving similar objects from each of the first file version and the second file version; (c) at a first of the plurality of data files, forming an object pair by pairing a first object received from the first file version with a first analog object received from the second file version; (d) comparing the pair of substantially identical objects of the object pair to detect a difference between the first object and the first analog object; and (e) identifying a change between the first file version and the second file version if the first object pair is not identical.

The disclosed embodiments may be implemented at one or more computers or at a cloud-based server. A system according to an embodiment of the disclosure comprises a processor circuit in communication with a memory circuit, the processor circuit storing instructions for directing the processor circuit to receive a first file version and a second file version of the 3D modeling file, each of the first file version and the second file version containing a plurality of objects; form a plurality of data files, each data file receiving similar objects from each of the first file version and the second file version; form an object pair at a first of the plurality of data files by pairing a first object received from the first file version with a first analog object received from the second file version; compare the pair of substantially identical objects of the object pair to detect a difference between the first object and the first analog object; and identify a change between the first file version and the second file version if the first object pair is not identical.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a flow diagram for implementing an embodiment of the disclosure;

FIG. 2 schematically illustrates a cloud-based model for identifying version changes in a 3D mode;

FIG. 3 schematically illustrates a system for identifying differences between 3D models;

FIG. 4 is a flow diagram schematically illustrating another embodiment of the disclosure; and

FIG. 5 is an exemplary 3D model showing the result of file comparison and highlights the change identified in the model.

### DETAILED DESCRIPTION

The disclosure provides a solution for identifying differences between different versions of an electronic design model. The design model may be 2D or 3D and may have multiple layers of complexity. The disclosed embodiments are particularly suited for complex engineering or architectural drawings where several groups work independently on different aspects of the design. The design model can be maintained at a remote server with significantly higher processing capability. Each working group may address a portion of the model, enter changes and save as a new version. Thus, the system allows several groups to independently work on the various aspects of the design, enter changes independently and save at a local or a remote server. The server may be a cloud-based server accessible to different team members. The project manager can access the various saved versions of the design and selectively compare one or more saved versions of the model electronically.

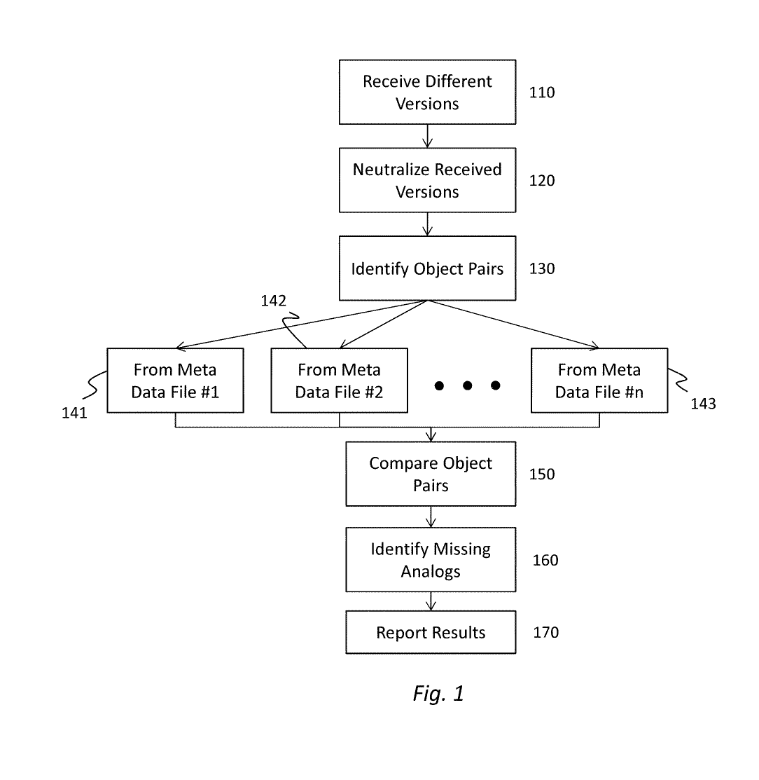

FIG. 1 is a flow diagram for implementing an embodiment of the disclosure. The models can be 3D or 2D models. At step 110, various versions of the 3D are selected for comparison. The selection process can be implemented by the reviewer and may include two or more version of the design model. Moreover, the versions may comprise the entire model or a portion thereof. For example, a 3D architectural model of a hospital may have a structural model showing the structural components and their layout as well as electrical, mechanical and pluming models. These models may be overlaid to form a composite model of the entire hospital. The models may also be separated for ease of file management such that different teams (e.g., architects and engineers) can simultaneously work on different parts of the model. Each team can independently save its changes in a new version on a server accessible to the other teams. At step 110, two or more different versions are selected for comparison.

Because the selected files (i.e., the first file version and the second file version) may contain different formats, at step 120, the selected file versions are neutralized to a uniform file format. This step is optional and may be unnecessary if the file versions have identical formats.

In 3D modeling, the models themselves are represented mathematically. For example, aggregations of lines and vectors may represent a physical object such as a door or a window. Using the mathematical model, the computer associates mathematical description to each object. The mathematical designation is identified as structural meta-data. Structural meta-data may include the name of the object, one or more identifier to distinguish the object from other objects of the same class or type, dimensional information, and location information. It should be noted that structures can be contained within (or collocated) with other objects (e.g., doors, windows etc.) The structural meta-data can be used to compare 3D models for difference.

At step 130 object pairs are identified from the first file version and the second file version. The objects can be lines, vectors, components (e.g., windows, doors, switches, etc.). In an embodiment where structural meta data is available, the system can load structural meta-data for the first model (e.g., the first file version) and the second model (e.g., the second file version).

The objects may also be classified based on their respective meta-data or other attributes. In an example where two versions of the same model are compared, substantially similar or identical objects can be paired in different files. This is shown as steps 141-143 where meta-data files are created to bin identical objects. Where an object in the first file version does not have an analog thereof in the second file version, the system will immediately detect an addition or deletion. In other words, if there are a greater or a fewer number of classes in the first file version compared to the second file version, the system knows that such class is either added or deleted. For example, a skylights may be added to a second file version of a design model. In this case, it is quickly known that all skylights are additions.

Similar or identical objects from the first file version and the second file version can be paired to form object pairs. The object pairs may also be examined to determine disparity between a first object (from the first file version) and its analog (from the second file version). This is illustrated at step 150 and is intended to identify changes within an object pair.

At step 160 missing analogs or object pair discrepancies are identified, and at step 170, the results are provided. The results may be displayed as highlighted portions of the model. Alternatively, the result may be provided as a list of discrepancies or changes between the file versions.

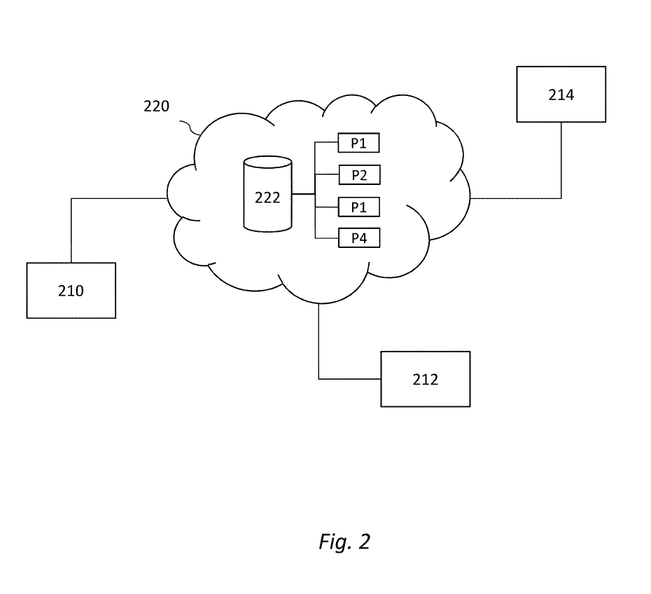

FIG. 2 schematically illustrates a cloud-based model for identifying version changes in a 3D mode. In FIG. 2, cloud-based server 220 is shown to include memory circuit 222 and processor circuits P1, P2, P3 and P4. Local computers 210, 212 and 214 communicate with cloud sever 220. The local computers can define accessing points to appropriate software running on cloud-based server 220. Local computers may be independent access points or can be part of a local access network. In one embodiment, local computer 210, 212 and 214 define independent contributors to the project.

Processor circuits P1-P4 can work independently of each other or they can work in concert to identify changes in the 3D model. For example, each of processors P-P4 may be given a portion of the 3D model for determining differences between the first file version and the second file version. Alternatively, each of processors P1-P4 can communicate with a master processor (not shown) in a master-slave set-up. Thus, the master processor may extract and assign portions of the 3D model to each of the processors P1-P4. Portions of the 3D model may define physical portions, different meta-data, or different layers of the file (e.g., structural, mechanical, electrical, etc.). Each processor will then identify differences in its respective 3D model portion and report the differences to the master processor. The master processor can then compile the differences and produce a final report. The final report may be visual or it may be a list of items, locations or portions that have been changed.

The change detection may not be limited to additions or deletions. The processor circuit may identify upgrades or model changes from one version to another. By ways of example, the first file version and the second file version may both include a heating unit. However, the second file version may have changed the heating unit to a different model with different capacity. Using the disclosed principles, the processor circuit can readily identify the change.

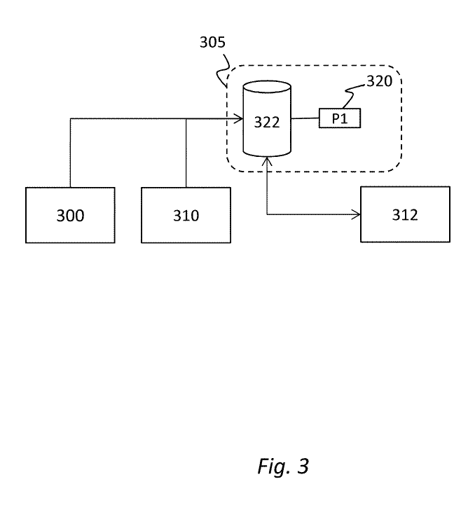

FIG. 3 schematically shows a system for identifying differences between 3D models. In the system of FIG. 3, computers 300, 310 and 312 are local workstations in communication with server 305. Server 305 includes memory circuit 322 and processor 320 in communication therewith. Memory circuit 322 retains the model understudy. Each of workstations 300, 310 and 312 communicates directly with server 305, accessing and creating different versions of the 3D model.

To identify the changes between various versions of the 3D model, processor 320 first retrieves the desired versions of the 3D model from memory circuit 322. Next, the meta-data for each of the first file version and a second file version of the 3D model are identified. For each object identified in the first file version of the 3D model, an analog object can be identified in the second file version. When there is no corresponding analog for an object (meta-data), then the object is deemed an addition or deletion. The processor can also identify a change when an object and its corresponding analog differ in shape, form or any other attribute.

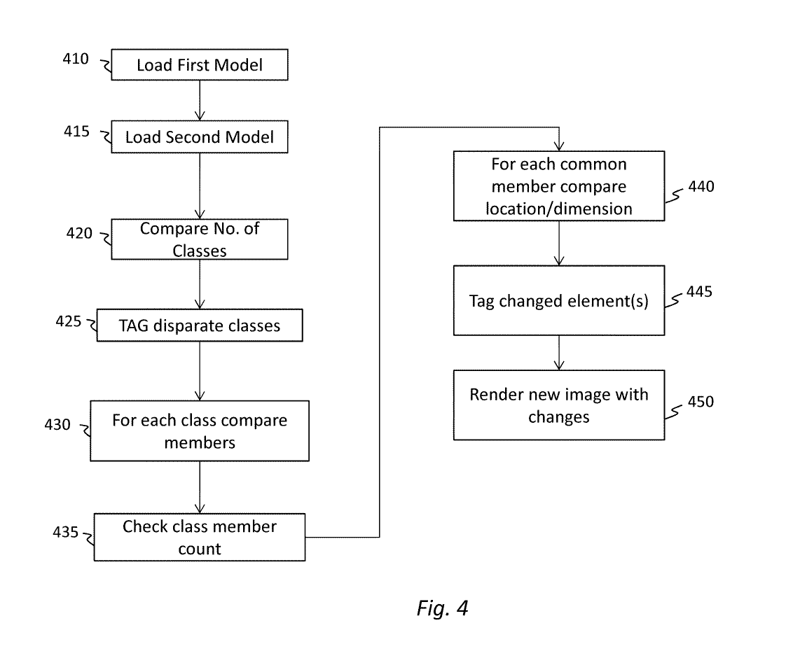

FIG. 4 is a flow diagram schematically illustrating another embodiment of the disclosure. At step 410, the system loads the structural meta-data for the first model. In FIG. 4, two different yet related files are compared. At step 415, the system loads the structural meta-data for the second model. It should be noted that while the exemplary embodiment of FIG. 4 compares two version of the 3D model, the inventive principles are not limited thereto and multiple versions can be compared using the steps disclosed herein. At step 420, the system compares the number of classes of structures between the models. If there are greater or fewer number of classes in the first model compared to the second model, the system knows that such class is either added or deleted. For example, in an architectural model, a skylight may be added in a second model whereas the first model lacks a skylight. In this case, it is quickly discerned that all skylights are additions, and therefore represent a change between the models. At step 425, for each disparate class, the system tags every member of the disparate class as a change to be displayed in an appropriate color when the comparison is presented.

For example, additions can be shown in blue, deletions in red, size changes in green and moves in orange. In other examples, a move might be shown in red in its original location and in blue in its new location. The system allows the user to determine the display parameters as the user desires to maximize readability.

For each common member of the class the system compares the location and dimensions of each member to determine if any changes have been made. This is shown at step 440. For dimensions, the structural meta-data may include dimensions as an element so that dimension comparison can be accomplished quickly. For location, the system may define an origin point for each object type (e.g., upper front left as the origin of any element). The origin of each element is compared and if there are no changes, and the overall dimensions have not changed, there will be no location change for that element. For any element that has a location and/or dimension change, the system tags that element as changed at step 545. Finally, at step 450, the system renders a new image with changes shown in appropriate colors.

In still another embodiment of the disclosure, 3D models are defined by point-set topology, algebraic topology, lists of primitives including Boolean constructions, vectors, curves, splines, polygon, vertexes, edges, wires, faces, shells, solids, and/or compound solids or forms. In some systems, the data is represented as a list of mathematical representations of one kind or another. For such embodiments, the system can use any of a number of comparison algorithms to identify changes. For example, the system may find an anchor point in a list of mathematical descriptors of the original model that matches an anchor point in the data list of a second, changed, model. The system can then start identifying predetermined differences before and after the anchor point to find matching descriptors. When no further matches are found, the system identifies a change point.

In another embodiment, a system that uses structural meta-data may implement a tracking system where a flag or tag is set if there is a change in the element. In this manner, the system can readily scan the list of elements to identify those elements that have a change tag and present those elements in a different color to represent the change. In a versioning environment, each structural element is given a version number when it changes. In this manner, the version number of each element is compared to the version number in the original model and only those having a difference are identified as changed elements.

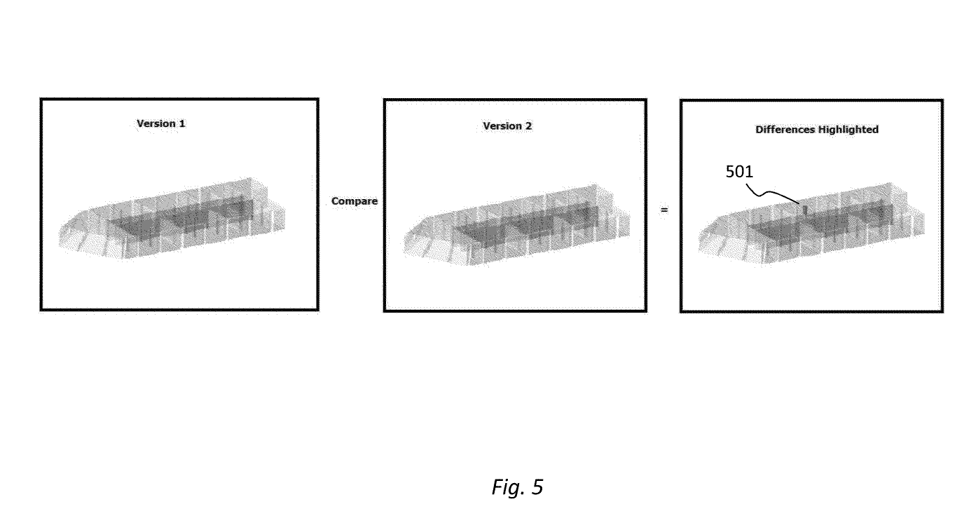

FIG. 5 is an exemplary 3D model showing the result of file comparison and highlights the change identified in the model. In FIG. 5, Version 1 of the model and Version 2 of the structural design model are compared. The highlighted differences show location 504 as being different between the versions. Location 504 can identify changes in dimension or addition/deletion of parts. It may also represent an equipment change. FIG. 5 illustrates the effectiveness of the disclosed embodiments in identifying changes that are not detectable by visual inspections.

While the principles of the disclosure have been illustrated in relation to the exemplary embodiments shown herein, the principles of the disclosure are not limited thereto and include any modification, variation or permutation thereof.

What is claimed is:

1. A method for identifying changes among different versions of a three-dimensional (“3D”) modeling file, the method comprising:
receiving at a processor a first file version and a second file version of the 3D modeling file, each of the first file version and the second file version containing a plurality of objects;
forming a plurality of data files, each data file receiving similar objects from each of the first file version and the second file version;
at a first of the plurality of data files, forming an object pair by pairing a first object received from the first file version with a first analog object received from the second file version;
comparing the pair of substantially identical objects of the object pair to detect a difference between the first object and the first analog object; and
identifying a change between the first file version and the second file version if the first object pair is not identical.

2. The method of claim 1, further comprising, neutralizing the first file version and the second file version to a common format.

3. The method of claim 1, further comprising a second object and the second analog object respectively residing in the first file version and the second file version.

4. The method of claim 1, wherein the first object and the first analog object are substantially identically.

5. The method of claim 1, wherein the first object and the first analog object are identically-located with respect to a reference point common to the first file version and the second file version.

6. The method of claim 1, wherein the objects define one or more of structural elements, mechanical elements, electrical element and plumbing elements.

7. The method of claim 1, further comprising identifying an object contained in one of the first file version or the second file version and not paired with an analog object.

8. The method of claim 1, further comprising linking a first object from the first file version to a substantially identical object from the second file version.

9. The method of claim 1, wherein similar objects define objects that are similarly classified.

10. A system for identifying changes among different versions of a three-dimensional (“3D”) modeling file, the system comprising a processor circuit in communication with a memory circuit, the processor circuit storing instructions directing the processor circuit to:
receive a first file version and a second file version of the 3D modeling file, each of the first file version and the second file version containing a plurality of objects;
form a plurality of data files, each data file receiving similar objects from each of the first file version and the second file version,
form an object pair at a first of the plurality of data files by pairing a first object received from the first file version with a first analog object received from the second file version;
compare the pair of substantially identical objects of the object pair to detect a difference between the first object and the first analog object; and
identify a change between the first file version and the second file version if the first object pair is not identical.

11. The system of claim 1, further comprising, neutralizing the first file version and the second file version to a common format.

12. The system of claim 1, further comprising a second object and the second analog object respectively residing in the first file version and the second file version.

13. The system of claim 1, wherein the first object and the first analog object are substantially identically.

14. The system of claim 1, wherein the first object and the first analog object are identically-located with respect to a reference point common to the first file version and the second file version.

15. The system of claim 1, wherein the objects define one or more of structural elements, mechanical elements, electrical element and plumbing elements.

16. The method of claim 1, further comprising identifying an object contained in one of the first file version or the second file version and not paired with an analog object.

17. The system of claim 1, further comprising linking a first object from the first file version to a substantially identical object from the second file version.

18. The system of claim 1, wherein similar objects define objects that are similarly classified.
